(19) United States
(12) Patent Application Publication
(10) Pub. No.: US 2010/0208484 A1
(43) Pub. Date: Aug. 19, 2010

(54) TRIBAR LIGHTING

(76) Inventor: Lawrence Andrew Hoffman, Portland, OR (US)

Correspondence Address: Silicon Forest Patent Group;Paul J. Fordenbacher, 11876 NW Tyler Ct, Portland, OR, 97229, US

(21) Appl. No.: 12/373,727

(22) PCT Filed: Jul. 13, 2007
(86) PCT No.: PCT/US2007/073547

§ 371 Date: Jan. 13, 2009

Related U.S. Application Data
(60) Provisional application No. 60/807,201, filed on Jul. 13, 2006.

(51) Int. Cl. B60Q 1/04; F21V 21/06

(52) U.S. Cl. 362/548; 362/375; 29/426.1

(57) ABSTRACT

Apparatus and methods of tribar headlights with removable/replaceable tribar elements are presented. In accordance with an embodiment, a tribar element assembly comprising a dot element and a retaining plug is removably coupled in a tribar hub allowing replacement and change out of the dot element through the bulb aperture of the lamp envelope.

### RELATED APPLICATION

This application is a PCT application claiming the benefit of U.S. Provisional Application No. 60/807,201, filed Jul. 13, 2006, incorporated herein in its entirety by reference

### FIELD

The present invention is related to lighting, and more particularly, to tribar headlights with removable/replaceable tribar elements.

### BACKGROUND

Many automobile and motorcycle enthusiasts consider it highly desirable to incorporate customized and personalized aesthetics into their stock or custom vehicles. Tribar headlights, also known as tripod headlights, are one such desirable aesthetic element that lends distinction to the vehicle. Tribar headlights were popular in the 1950's and 1960's and add an authentic or classic touch to the enthusiast's vehicle.

One historical tribar headlight is the Lucas Electric LTD P700 which was supplied to the British car industry in the 1950's and 1960's. The P700 was distinctive in that the headlight 100 contained a tripod support 120 that supported a focusing shield 107 within the light beam as shown in FIGS. 1 and 2. The tripod support 120 includes three tripod arms 121 that radiate outward from a tripod hub 123. The tripod arms 121 terminate so as to couple with the perimeter edge 132 of a lamp body 130. The tripod arms 121 support the tripod hub 123 within the light beam and substantially along the optical axis of the lamp body 130. The lamp body 130 had a parabolic shape with a reflective inner surface 133. The focusing shield 107 was coupled to the tripod hub 123 and aligned for proper optical characteristics. The focusing shield 107 had a concave reflective surface 117 that was effective in focusing and concentrating the light from a filament bulb 108 that was placed in the focus of the lamp body 130. An emblem disk 141 bearing the Lucas name was coupled to the tripod hub 123 by a retaining nut 129 for prominent display when the headlight 100 was viewed from the front. The emblem disk 141 and the tripod arms 121 were clearly seen when the headlight 100 was viewed from the front.

Periodic maintenance of the tribar headlight 100 was required as the reflective surfaces 117 and 133 would become discolored, corroded and otherwise needing cleaned or replaced. The lamp body 130 was made of metal having a peripheral edge 132 that was crimped over the ends of the tripod arms 121 and a peripheral edge 142 of a front glass 140. The crimped peripheral edge 132 could be uncrimped in order to remove the front glass 140 and the tripod support 120.

In later years the focusing shield was no longer necessary but the classic appearance of the tripod support was still desired and retained within the headlight. The tripod hub was changed to a ring and the emblem was replaced with a translucent, commonly blue-colored glass or lens. These headlights became known as the “blue dot” tribar headlights referring to the lens. Further, headlights evolved such that the separate metal lamp body 130 and front glass 140 has been replaced by a unitary all-glass envelope that precludes access to the tripod support 120.

The availability of tribar headlights is very limited to only a few stock sizes and “dot” colors. The market for tribar headlights is relatively limited and it is prohibitively expensive to provide all the sizes, colors, and wattages that the marketplace requires. Therefore the enthusiast is required to contend with adaptor kits and other modifications in order to incorporate the tribar headlight into the vehicle.

An alternative that is offered to enthusiasts is a clip-on tribar element that attaches to the outside of the front lens of stock headlights. The tribar element is captured between the perimeter of the front lens and the headlight circumferential trim ring, or adhesively coupled to the front lens. The clip-on tribar elements are a poor substitute for the reproduction tribar headlights that have the tribar assembly inside of the headlight. The clip-on tribar elements do not provide a smooth headlight front surface, are hard to clean, are prone to damage, and are aesthetically unpleasing presenting a cheap, fake appearance.

It would, therefore, be highly desirable to have a tribar headlight that provides the tribar assembly within the headlight in keeping with the classic style, is less expensive to manufacture, and provides the manufacture, dealer or the purchaser the ability to change-out the “dot” to a different color or emblem to change the aesthetics of the headlight without the high cost associated with inventory burdens and major assembly and change-out issues.

### BRIEF DESCRIPTION OF THE DRAWINGS

Like reference numbers generally indicate corresponding elements in the figures.

FIG. 1 is a front view of a tribar headlight known in the art;

FIG. 2 is a side view of a tribar headlight known in the art;

FIG. 3 is a top view of a tribar headlight in accordance with an embodiment of the present invention;

FIG. 4 is a side view of a tribar headlight of the embodiment of FIG. 3;

FIG. 5 is a top view of a threaded dot element assembly comprising a dot element and a threaded retainer ring, in accordance with an embodiment of the present invention;

FIG. 6 is a side exploded view of the threaded dot element assembly and a partial view of the tripod hub, in accordance with an embodiment of the present invention;

FIG. 7 is a plan exploded view of a dot element assembly and a partial view of the tribar support, in accordance with an embodiment of the present invention;

FIG. 8 is a plan exploded view of a dot element assembly and a partial view of the tribar support, in accordance with an embodiment of the present invention;

FIG. 9 is a plan exploded view of a dot element assembly and a partial view of the tribar support, in accordance with an embodiment of the present invention;

FIG. 10 is a perspective exploded view of a dot element assembly and a partial view of the tribar support, in accordance with an embodiment of the present invention;

FIG. 11 is a perspective view of an assembled dot element assembly and tribar support within an envelope body portion, in accordance with an embodiment of the present invention; and

FIG. 12 is a perspective exploded view of a dot element assembly and a partial view of the tribar support, in accordance with an embodiment of the present invention.

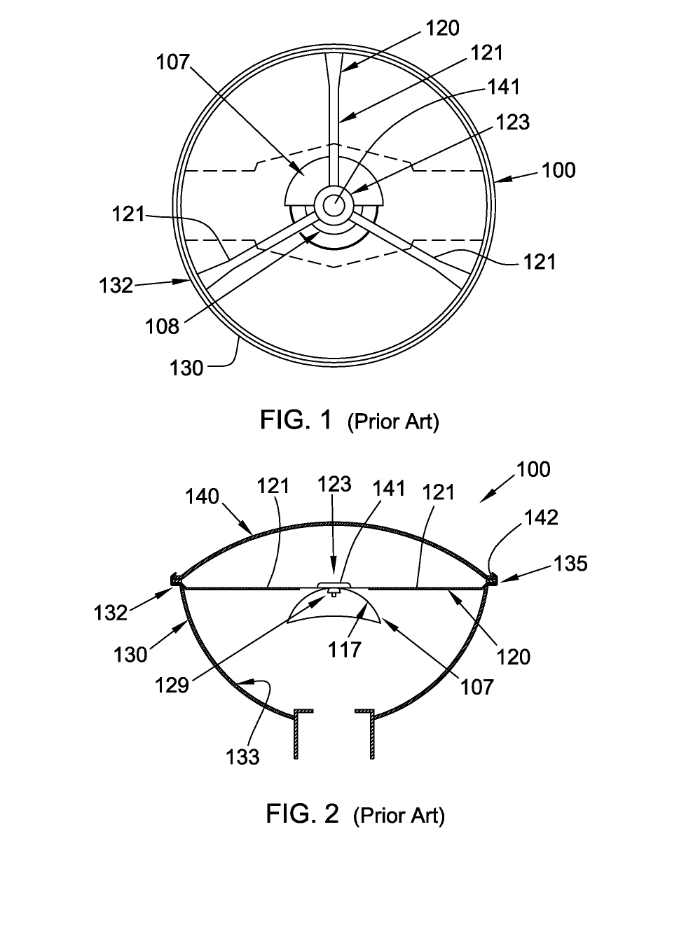

### DETAILED DESCRIPTION

References will now be made to embodiments illustrated in the drawings and specific language which will be used to describe the same. It will nevertheless be understood that no limitation of the scope of the invention is thereby intended, such alterations and further modifications in the illustrated devices, as such further applications of the principles of the invention as illustrated therein as being contemplated as would normally occur to one skilled in the art to which the invention relates.

Embodiments in accordance with the present invention relate to providing a tribar headlight with removable and interchangeable tribar elements.

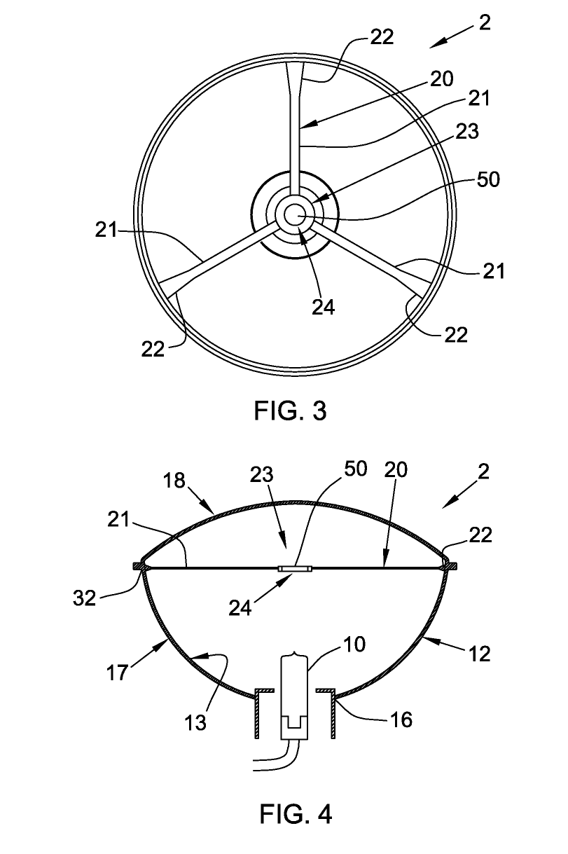

FIGS. 3 and 4 are top and side views of a tribar headlight 2 in accordance with an embodiment of the present invention. The tribar headlight 2 comprises a one-piece glass envelope 12, a tribar support 20, and a removable bulb 10. The envelope 12 includes a body portion 17 and a translucent front portion 18. The body portion 17 includes an optically configured reflective surface 13 that reflects and directs the light produced by the bulb 10. The body portion 17 includes a bulb aperture 16 for receiving at least a portion of the bulb 10 from external the envelope 12 to internal the envelope 12. The bulb 10 is removable from the body portion 17 so as to allow replacement as well as access to a dot element 50.

The body portion 17 and the translucent front portion 18 meet to define a perimeter edge 33. The embodiment of FIG. 3 provides a headlight 2 that has a generally circular top-view profile. It is understood that other top-view profiles, such as, but not limited to, oval, may be provided without departing from the scope of the invention.

The envelope 12 is described as being a one-piece glass configuration, but it is appreciated that envelope may comprise other configurations and materials. Other configurations include multiple components such as, but not limited to, a lamp body and a front glass as shown in FIG. 2. Other materials include, but are not limited to, glass, metal, and polycarbonate.

The tribar support 20 comprises three tripod arms 21 that radiate outward from a tripod hub 23. The tribar support 20 is contained within the envelope 12. The tripod arms 21 terminate so as to couple with the inside of the perimeter edge 32 of the envelope 12. The tripod arms 21 support the tripod hub 23 within the light beam and substantially along the optical axis of the body portion 17. The tripod hub 23 is adapted to removably couple with and support a dot element 50 as described below. The tripod hub 23 defines a hub aperture 24. The hub aperture 24 is adapted to accept the dot element 50 therein. The hub 23 comprises elements for removably coupling with dot element 50 or with a dot element assembly including a dot element 50.

The tribar support 20 comprises a material suitable for the particular purpose, such as, but not limited to, stainless steel, painted steel, aluminum, colored anodized aluminum, and plastic.

The dot element 50 is coupled to the tripod hub 23 and aligned for desired optical characteristics.

The dot element 50 may comprise any number of decorative and/or functional elements suitable for a particular purpose. The dot element 50 is generally disk shaped as shown in FIGS. 3 and 4, but it is understood that the dot element 50 can comprise any geometric shape suitable for a particular purpose, such as, but not limited to, oval, square, triangle, and hexagon.

In an embodiment, the dot element 50 is translucent and tinted an aesthetically pleasing color. The dot element 50 comprises a material suitable for a particular purpose, such as, but not limited to, glass and polycarbonate. In an embodiment, light from the bulb 10 is caused to illuminate through the dot element 50.

In another embodiment, the dot element 50 is a non-translucent material such as, but not limited to, stainless steel, aluminum, colored anodized aluminum, and plastic, and may be engraved with a design or brand identification.

The dot element 50 is removably coupled to the tripod hub 23 for prominent display when the headlight 2 is viewed from the front. The dot element 50 and the tripod arms 21 are clearly seen when the headlight 2 is viewed from the front.

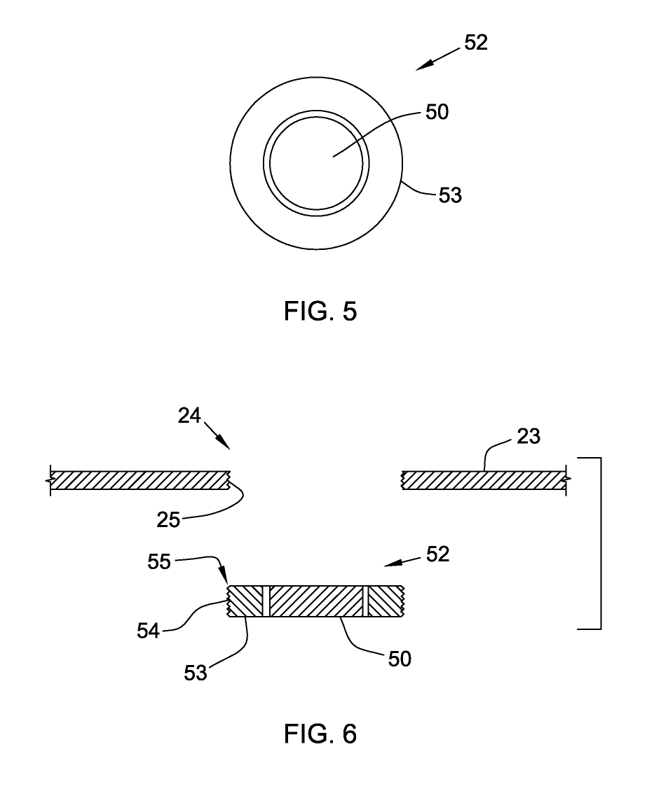

FIG. 5 is a top view of a threaded dot element assembly 52 comprising a dot element 50 and a threaded retainer ring 53, in accordance with an embodiment of the present invention. FIG. 6 is a side exploded view of the threaded dot element assembly 52 and a partial view of the tripod hub 23. The threaded retainer ring 53 is coupled to the dot element 50 about a perimeter of the dot element 50. The threaded retainer ring 53 comprises ring threads 54 about a perimeter 55. The threaded retainer ring 53 further comprises tool elements (not shown) suitable for engaging a tool to assist in installing and removing the dot element assembly 52 from the hub 23. Tool elements may include, but not limited to, slots, pegs, and dimples that engage a tool so as to allow the tool to rotate the dot element assembly 52 relative to and within the hub aperture 24.

The hub aperture 24 comprises aperture threads 25 for removable engagement with the ring threads 54 of the threaded retainer ring 53.

Referring also to FIG. 4, the bulb aperture 16 of the body portion 17 is configured to allow the dot element assembly 52 to pass through. The dot element assembly 52 may be coupled with and removed from the hub 23 using a suitable tool passing through the bulb aperture 16, wherein the bulb 10 having been removed.

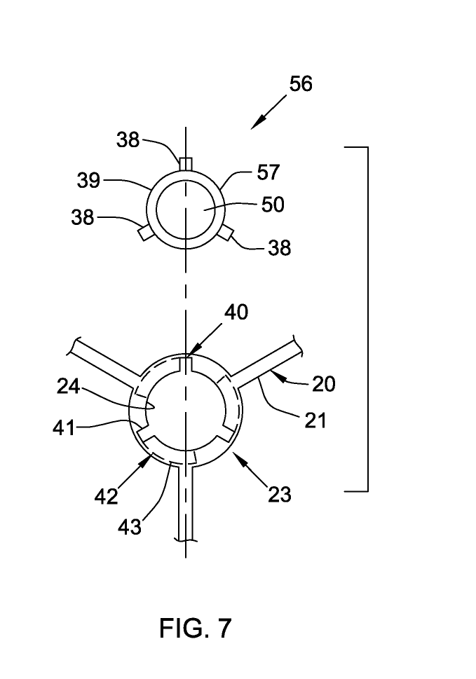

FIG. 7 is a plan exploded view of a dot element assembly 56 and a partial view of the tribar support 20, in accordance with an embodiment of the present invention. The dot element assembly 56 comprises a dot element 50 and a ring 57. The ring 57 is coupled to the dot element 50 about a perimeter of the dot element 50. The ring 57 comprises a plurality of key tabs 38 about a perimeter 39. The ring 57 further comprises tool elements (not shown) suitable for engaging a tool to assist in installing and removing the dot element assembly 56 from the hub 23. Tool elements may include, but not limited to, slots, pegs, and dimples that engage the tool so as to allow the tool to rotate the dot element assembly 56 relative to and within the hub 23.

The hub 23 comprises a respective keyway 40 for removable engagement with each of the key tabs 38 of the ring 57. The keyway 40 is adapted to accept the key tab 38 therein and engage the key tab 38 when the ring 57 is rotated relative to the hub 23. The engagement may be facilitated by friction, locking means, capture means, among others.

In an embodiment, the keyway 40 defines a tapered slot 42 adapted to engage the key tab 38. The keyway 40 comprises a key notch 41 and a tapered outwardly extending side portion 43. Each of the key notches 41 are adapted to accept a respective key tab 38 of the ring 57 therethrough with the key tab 38 engaging respective side portions 43 when the ring 57 is rotated. A friction engagement between the key tabs 38 and the side portions 43 removably couples the dot element assembly 56 to the tribar hub 23.

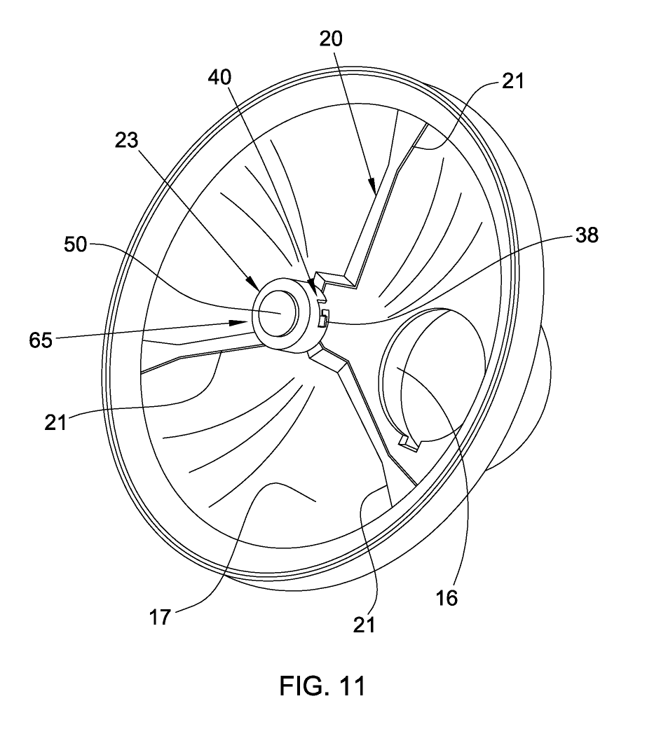

In another embodiment, the keyway 40 defines locking features that engage the key tab 38 to prevent undesired disengagement. Suitable locking features include, but not limited to, detent/extend elements, spring-biasing of the key tab 38, as well as retention of the key tab 38 within a tab slot 47 by a locking tab 49 as shown in the embodiment of FIG. 10.

The bulb aperture 16 of the body portion 17 is configured to allow the dot element assembly 56 to pass through. The dot element assembly 56 may be coupled with and removed from the hub 23 using a suitable tool passing through the bulb aperture 16, wherein the bulb 10 having been removed.

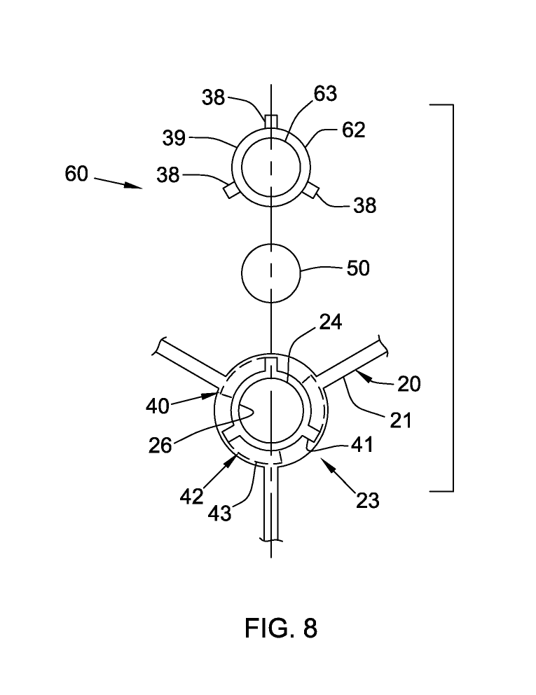

FIG. 8 is a plan exploded view of a dot element assembly 60 and a partial view of the tribar support 20, in accordance with an embodiment of the present invention. The dot element assembly 60 comprises a dot element 50 and a plug 62. The plug 62 is adapted to couple the dot element 50 to the tripod hub 23. The plug 62 comprises a plurality of key tabs 38 about a perimeter 39. The plug 62 further comprises tool elements (not shown) suitable for engaging a tool to assist in installing and removing the dot element assembly 60 from the hub 23. Tool elements may include, but not limited to, slots, pegs, and dimples that engage the tool so as to allow the tool to rotate the dot element assembly 60 relative to and within the hub aperture 24.

The hub 23 comprises a respective keyway 40 for removable engagement with each of the key tabs 38 of the plug 62. The keyway 40 is adapted to accept the key tab 38 therein and engage the key tab 38 when the plug 62 is rotated relative to the hub 23. The engagement may be facilitated by friction, locking means, capture means, among others.

In an embodiment, the keyway 40 defines a tapered slot 42 adapted to engage the key tab 38. The keyway 40 comprises a key notch 41 and a tapered outwardly extending side portion 43. Each of the key notches 41 are adapted to accept a respective key tab 38 of the plug 62 therethrough with the key tabs 38 engaging respective side portions 43 when the plug 62 is rotated. A friction engagement between the key tabs 38 and the side portion 43 removably couples the dot element assembly 60 to the tribar hub 23.

In another embodiment, the keyway 40 defines locking features that engage the key tab 38 to prevent undesired disengagement. Suitable locking features include, but not limited to, detent/extend elements, spring-biasing of the key tab 38, as well as retention of the key tab 38 within a tab slot 47 by a locking tab 49 as shown in the embodiment of FIG. 10.

The hub 23 further comprises a lip 26 about the hub aperture 24 adapted to engage the perimeter edge of the dot element 50 when the dot element 50 is located within the hub 23. The dot element 50 is retained between the plug 62 and the lip 26 when assembled.

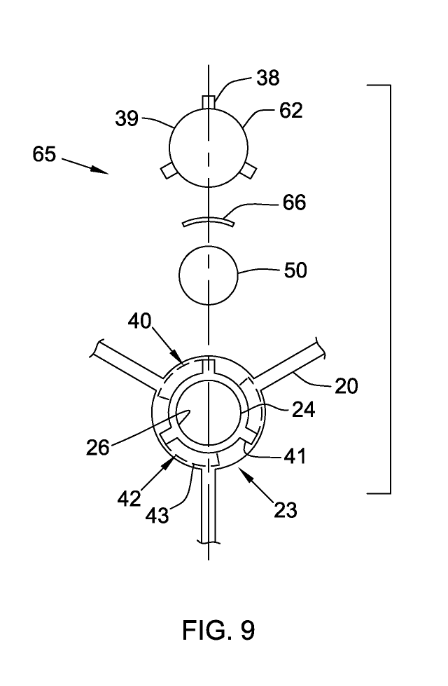

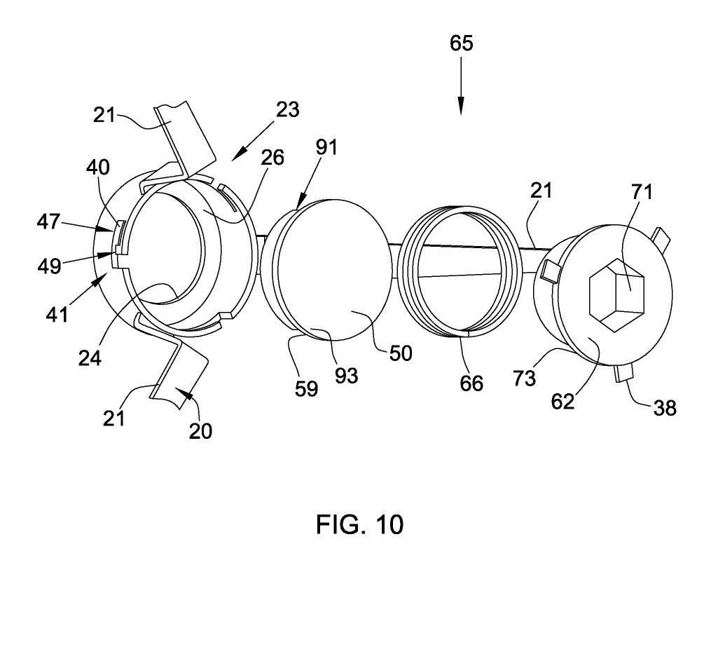

FIG. 9 is a plan exploded view of a dot element assembly 65 and a partial view of the tribar support 20, in accordance with an embodiment of the present invention. The dot element assembly 65 comprises a dot element 50, a biasing member 66, and a plug 62. The plug 62 is adapted to couple the dot element 50 to the tripod hub 23. The biasing member 66 is adapted to apply a biasing force between the dot element 50 and the plug 62. The plug 62 comprises a plurality of key tabs 38 about a perimeter 39. The plug 62 further comprises tool elements (not shown) suitable for engaging a tool to assist in installing and removing the dot element assembly 65 from the hub 23. Tool elements may include, but not limited to, slots, pegs, and dimples that engage the tool so as to allow the tool to rotate the dot element assembly 65 relative to and within the hub aperture 24.

The hub 23 comprises a respective keyway 40 for removable engagement with each of the key tabs 38 of the plug 62. The keyway 40 is adapted to accept the key tab 38 therein and engage the key tab 38 when the plug 62 is rotated relative to the hub 23. The engagement may be facilitated by friction, locking means, capture means, among others.

In an embodiment, the keyway 40 defines a tapered slot 42 adapted to engage the key tab 38. The keyway 40 comprises a key notch 41 and a tapered outwardly extending side portion 43. Each of the key notches 41 are adapted to accept a respective key tab 38 of the plug 62 therethrough with the key tabs 38 engaging respective side portions 43 when the plug 62 is rotated. A friction engagement between the key tab 38 and the side portion 43 removably couples the dot element assembly 65 to the tribar hub 23.

In another embodiment, the keyway 40 defines locking features that engage the key tab 38 to prevent undesired disengagement. Suitable locking features include, but not limited to, detent/extend elements, spring-biasing of the key tab 38, as well as retention of the key tab 38 within a tab slot 47 by a locking tab 49 as shown in the embodiment of FIG. 10.

The hub 23 further comprises a lip 26 about the hub aperture 24 adapted to engage the perimeter edge of the dot element 50 when the dot element 50 is placed within the hub aperture 24. The dot element 50 is retained between the plug 62 and the lip 26 with the dot element 50 biasedly urged against the lip 26 by the biasing element 66 when assembled. The biased engagement provides a secure coupling of the dot element 50 with the hub 23. Further, the biased engagement ensures that the dot element 50 does not rattle due to vibration and the like. The biasing element 66 may be any resilient element suitable for the particular purpose, such as, but not limited to, a wire spring, a curved plate, a rubber disk, a rubber washer, and a split metal washer.

In an embodiment, the plug 62 comprises a plug aperture 63 to allow light to pass from the bulb through the plug aperture 63 to the dot element 50.

The tribar headlight 2 is manufactured having the tribar support 20 contained within the envelope 12. The dot element and the bulb 10 may be assembled at the manufacturer, at the dealer, or by the consumer.

The dot element 50 may be removed from the tribar headlight 2 by first removing the bulb 10 and by use of a tool, turning the plug 62 with respect to the hub 23, disengaging the dot element assembly 65 from the hub 23. The dot element assembly is thus removed from the headlight through the bulb aperture 16. A replacement dot element assembly is inserted through the bulb aperture 16 and coupled to the hub 23 with the assistance of a tool.

FIG. 10 is a perspective exploded view of a dot element assembly 65 and a partial view of the tribar support 20, in accordance with an embodiment of the present invention. FIG. 11 is a perspective view of an assembled dot element assembly 65 and tribar support 20 of the embodiment of FIG. 10 within an envelope body portion 17, in accordance with an embodiment of the present invention. The dot element assembly 65 comprises a dot element 50, a biasing member 66, and a plug 62. The plug 62 is adapted to couple the dot element 50 to the tripod hub 23. The biasing member 66 is adapted to apply a biasing force between the dot element 50 and the plug 62. The plug 62 comprises a plurality of key tabs 38 about a perimeter 39. The plug 62 further comprises a tool element 71 suitable for engaging a tool to assist in installing and removing the dot element assembly 65 from the hub 23. The plug 62 further comprises a plug perimeter lip 73 for engaging the biasing member 66.

The hub 23 comprises a respective keyway 40 for removable engagement with each of the key tabs 38 of the plug 62. The keyway 40 is adapted to accept the key tab 38 therein and engage the key tab 38 when the plug 62 is rotated relative to the hub 23. The engagement is facilitated by locking means comprising an engagement slot 47 and an engagement tab 49. Each key tab 38 enters and rotates within a respective engagement slot 47 and is retained within the engagement slot 47 by the combination of the engagement tab 49 and the urging bias of the biasing member 66.

The hub 23 further comprises a lip 26 about the hub aperture 24 adapted to engage a front perimeter edge 59 of the dot element 50 when the dot element 50 is placed within the hub 23. The dot element 50 further comprises a front portion 91 that is adapted to extend within and through the hub aperture 24. The dot element 50 is retained between the plug 62 and the lip 26 with the dot element 50 biasedly urged against the lip 26 by the biasing element 66, the biasing element 66 engaging a dot element front perimeter edge 93 of the dot element 50, and wherein the biasing member 66 engaging the plug perimeter lip 73 when assembled. The biased engagement provides a secure coupling of the dot element 50 and the plug 62 with the hub 23. Further, the biased engagement ensures that the dot element 50 does not rattle due to vibration and the like. The biasing element 66 may be any resilient element suitable for the particular purpose, such as, but not limited to, a wire spring, a curved plate, a rubber disk, a rubber washer, and a split metal washer.

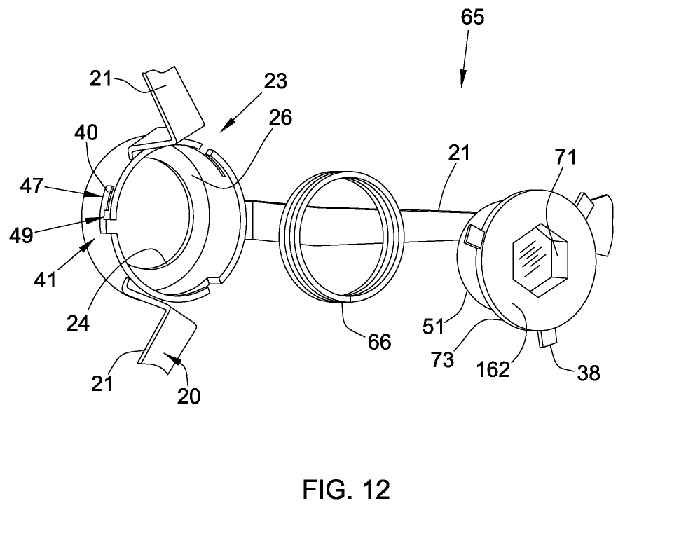

FIG. 12 is a perspective exploded view of a dot element assembly 65 and a partial view of the tribar support 20, in accordance with an embodiment of the present invention. In this embodiment, the plug 162 has a front portion 51 that replaces the dot element 50 of the embodiment of FIG. 10. The dot element assembly 65 comprises a biasing member 66 and a plug 162. The plug 162 is adapted to couple to the hub 23.

The hub 23 comprises a respective keyway 40 for removable engagement with each of the key tabs 38 of the plug 162. The keyway 40 is adapted to accept the key tab 38 therein and engage the key tab 38 when the plug 162 is rotated relative to the hub 23. The engagement is facilitated by locking means comprising an engagement slot 47 and an engagement tab 49. Each key tab 38 enters and rotates within a respective engagement slot 47 and is retained within the engagement slot 47 by the combination of the engagement tab 49 and the urging bias of the biasing member 66.

The hub 23 further comprises a lip 26 about the hub aperture 24 adapted to engage and contain the biasing element 66. The plug 162 further comprises a front portion 51 that is adapted to extend within and through the hub aperture 24. The plug 162 defines a perimeter lip 73 for engagement with the biasing element 66. The plug 162 is retained within the hub 23 with the biasing element engaging the lip 26 and the plug perimeter lip 73 of the plug 162 with the key tabs 38 retained in the keyways 40. The biasing element 66 may be any resilient element suitable for the particular purpose, such as, but not limited to, a wire spring, a curved plate, a rubber disk, a rubber washer, and a split metal washer.

The plug 62 further comprises a tool element 71 suitable for engaging a tool to assist in installing and removing the plug 162 from the hub 23.

It is appreciated that the features of the tribar headlight as described above may be utilized for other lighting configurations, such as, but not limited to, automobile interior lighting, exterior lighting, commercial lighting, residential lighting, portable lighting, and other lighting applications.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

What is claimed is:

1. A tribar light comprising:
a light bulb;
an envelope having a body portion and a translucent portion, the envelope defining an interior perimeter edge, the body portion defining a bulb aperture for receiving at least a portion of the light bulb from external the envelope to internal the envelope, the light bulb is operable to be removably coupled to the bulb aperture;
a tribar support including a tripod hub and three tripod arms that radiate outward from a tripod hub, the tribar support being contained within the envelope, the tripod arms being coupled with the interior perimeter edge; and
a dot element assembly, the tripod hub is operable to removably couple with and support the dot element assembly, the dot element assembly is operable to pass through the bulb aperture.

2. The tribar light of claim 1, wherein the tripod arms support the tripod hub within the light beam and substantially along the optical axis of the body portion.

3. The tribar light of claim 1, wherein the dot element assembly includes a dot element, the tripod hub defines a hub aperture, the hub aperture is operable to accept a dot element therein.

4. The tribar light of claim 1, wherein the dot element assembly comprises a dot element and a threaded retainer ring, the threaded retainer ring being removably coupled to the dot element about a perimeter of the dot element, the retainer ring comprising ring threads about a perimeter, the hub aperture comprising aperture threads for removable coupling with the ring threads of the threaded retainer ring.

5. The tribar light of claim 1, wherein the dot element assembly comprises a dot element and a key ring, the key ring is coupled to the dot element about a perimeter of the dot element, the key ring comprising a plurality of key tabs about a perimeter, the hub aperture comprising a respective keyway for removable engagement with one of the key tabs of the key ring, the keyway is operable to accept the key tab therein and engage the key tab when the key ring is rotated relative to the hub

6. The tribar light of claim 5, wherein the keyway defines a tapered slot is operable to engage a respective key tab.

7. The tribar light of claim 5, wherein the keyway comprises a key notch and a tapered outwardly extending side portion, the key notch is operable to accept a respective key tab of the key ring therethrough with the key tabs being operable to frictionally engage respective side portions when the key ring is rotated.

8. The tribar light of claim 5, wherein the keyway defines locking features that engage the key tabs to prevent undesired disengagement.

9. The tribar light of claim 5, wherein the keyway defines a tab slot and a locking tab, the tab slot is operable to receive the key tab with the locking tab retaining the key tab within the tab slot.

10. The tribar light of claim 1, wherein the dot element assembly comprises a dot element and a plug, the plug is operable to couple the dot element to the tripod hub, the plug comprising a plurality of key tabs about a perimeter, the hub comprising a respective keyway for removable coupling with a key tab of the key ring, the keyway is operable to accept the key tabs therein and engage the key tabs when the key ring is rotated relative to the hub.

11. The tribar light of claim 10, wherein the hub further comprises a lip about the hub aperture is operable to engage the peripheral edge of the dot element when the dot element is placed within the hub aperture, the dot element being removably retained between the plug and the lip.

12. The tribar light of claim 1, wherein the dot element assembly comprises a dot element, a biasing member, and a plug, the plug is operable to couple the dot element to the tripod hub, the biasing member is operable to apply a biasing force between the dot element and the plug, the plug comprising a plurality of key tabs about a perimeter, the hub comprising a respective keyway for removable engagement with a key tab of the key ring, the keyway is operable to accept the key tabs therein and engage the key tabs when the key ring is rotated relative to the hub.

13. The tribar light of claim 12, wherein the hub further comprising a lip being operable to engage the peripheral edge of the dot element, the dot element is removably retained between the plug and the lip with the dot element biasedly urged against the lip by the biasing element.

14. The tribar light of claim 12, wherein the plug comprises a plug aperture to allow light to pass from the bulb to the dot element.

15. The tribar light of claim 12, wherein the keyway defines a tapered slot being operable to engage a respective key tab.

16. The tribar light of claim 12, wherein the keyway comprises a key notch and a tapered outwardly extending side portion, the key notch is operable to accept a respective key tab of the key ring therethrough with the key tabs being operable to frictionally engage respective side portions when the key ring is rotated.

17. The tribar light of claim 12, wherein the keyway defines locking features that engage the key tabs to prevent undesired disengagement.

18. The tribar light of claim 12, wherein the keyway defining a tab slot and a locking tab, the tab slot is operable to receive the key tab with the locking tab retaining the key tab within the tab slot.

19. The tribar light of claim 1, wherein the dot element assembly comprises a dot element, a biasing member, and a plug, the plug is operable to couple the dot element to the tripod hub, the biasing member is operable to apply a biasing force between the dot element and the plug, the plug comprises a plurality of key tabs about a perimeter, the plug further comprises a plug perimeter lip for engaging the biasing member, the hub comprises a respective keyway for removable engagement with each of the key tabs of the plug, the keyway is operable to accept the key tabs therein and engage the key tabs, the keyway comprises an engagement slot and an engagement tab, the engagement slot is operable to receive the key tab, the key tab retained within the engagement slot by the engagement tab and the urging bias of the biasing member, the hub further comprising a lip about the hub aperture is operable to engage the front perimeter edge of the dot element when the dot element is located within the hub, the dot element is removably retained between the plug and the lip with the dot element biasedly urged against the lip by the biasing element, the biasing element engaging a dot element front perimeter edge of the dot element, and wherein the biasing member engages the plug perimeter lip.

20. The tribar light of claim 19, wherein the dot element further comprises a front portion being operable to extend within and through the hub aperture.

21. The tribar light of claim 19, wherein the keyway defines a tapered slot being operable to engage a respective key tab.

22. The tribar light of claim 19, wherein the keyway comprises a key notch and a tapered outwardly extending side portion, the key notch is operable to accept a respective key tab of the key ring therethrough with the key tabs being operable to frictionally engage respective side portions when the key ring is rotated.

23. The tribar light of claim 19, wherein the keyway defines locking features that engage the key tabs to prevent undesired disengagement.

24. The tribar light of claim 19, wherein the keyway defines a tab slot and a locking tab, the tab slot being operable to receive the key tab with the locking tab retaining the key tab within the tab slot.

25. The tribar light of claim 1, wherein the dot element assembly comprises a biasing member and a plug, the plug is operable to couple to the hub, the hub comprises a respective keyway for removable engagement with each of the key tabs of the plug, the keyway is operable to accept a key tab therein and engage the key tab.

26. The tribar light of claim 25, wherein the hub further comprises a lip about the hub aperture being operable to engage and contain the biasing element, the plug further comprises a front portion that is operable to extend within and through the hub aperture, the plug defines a perimeter lip for engagement with the biasing element, the plug is removably retained within the hub with the biasing element engaging the lip and the plug perimeter lip of the plug with the key tabs retained in the keyways.

27. The tribar light of claim 26, wherein the keyway defines a tapered slot being operable to engage a respective key tab.

28. The tribar light of claim 26, wherein the keyway comprises a key notch and a tapered outwardly extending side portion, the key notch being operable to accept a respective key tab of the key ring therethrough with the key tabs being operable to frictionally engage respective side portions when the key ring is rotated.

29. The tribar light of claim 26, wherein the keyway defines locking features that engage the key tabs to prevent undesired disengagement.

30. The tribar light of claim 26, wherein the keyway defines a tab slot and a locking tab, the tab slot is operable to receive the key tab with the locking tab retaining the key tab within the tab slot.

31. A tribar headlight comprising:
an envelope including an aperture;
a light bulb removably coupled to the aperture;
a tribar assembly contained within the envelope; and
a dot element removably coupled to the tribar assembly, the dot element being operable to pass through the aperture when the light bulb is removed from the aperture.

32. A method for removing a dot element from a tribar headlight, the tribar headlight including an envelope including an aperture, a light bulb removably coupled to the aperture, a tribar assembly contained within the envelope, and a dot element removably coupled to the tribar assembly, the dot element being operable to pass through the aperture in the envelope, the method comprising:
removing the light bulb;
disengaging the dot element assembly from the hub aperture; and
removing the dot element assembly from the headlight through the aperture.

33. (canceled)
